(19) United States
(12) Patent Application Publication
(10) Pub. No.: US 2018/0249005 A1
(43) Pub. Date: Aug. 30, 2018

(54) SYSTEM AND METHOD FOR IDENTIFYING, AUTHENTICATING, AND PROCESSING AN AUTOMATED CALL

(71) Applicant: AT&T Intellectual Property I, L.P., Atlanta, GA (US)

(72) Inventors: Sangar Dowlatkhah, Alpharetta, GA (US); Venson Shaw, Kirkland, WA (US)

(21) Appl. No.: 15/445,876

(22) Filed: Feb. 28, 2017

(51) Int. Cl. H04M 3/436; H04M 3/22; H04M 3/42; H04W 4/16

(52) U.S. Cl. CPC H04M 3/436; H04M 3/2281; H04M 2203/6027; H04W 4/16; H04M 3/42059

(57) ABSTRACT

A system can be operable to receive a call from a communications device and identify whether the call is an automated call (e.g., robocall) from an automated dialer by determining whether its caller identification number (caller ID number) has been spoofed, and determine whether the call is part of a pattern consistent with automated calls. In response to the identification of the call as an automated call, the system can determine whether the call is approved for connection to the call destination by querying one or more databases.

### TECHNICAL FIELD

The present application relates generally to the field of privacy, and, for example, to identifying, authenticating, and processing an automated call.

### BACKGROUND

in today's busy world, receiving calls at inconvenient times can be very annoying, especially if a called party is not interested in the subject matter to which the calls relate, or if the called party receives repeated calls at inopportune times. There has been an increase in the number of automated calls (e.g., robocalls) in which a large number of calls are automatically directed to called parties by automated callers, which typically play a pre-recorded message for the called parties. There has been some effort to reduce and even limit such calls by enforcing the laws in which called parties on a “do not call” list are not be called. However, the majority of these automated calls do not even originate from the United States. There are large call centers in remote corners of the world where U.S. laws are inapplicable, or the calling parties simply ignore the applicable laws. Additionally, there have been incidences in which robocall systems have been used maliciously to perpetrate fraudulent transactions. According to the federal communications commission (FCC), it received more than 214,000 complaints about unwanted calls in 2014.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example system and networking environment for accessing on-line services and products.

FIG. 2 illustrates an example system and networking environment in which an automated dialer calls multiple user equipment.

FIG. 3 is a diagram illustrating transactions between an example automated dialer and a called party user equipment.

FIG. 4 is a flow chart illustrating an example of a called party's typical experience interacting with an automated dialer.

FIG. 5 is a block diagram providing an overview of an example process that can be performed by an automated call detection and processing system in accordance with various aspects and embodiments of the subject disclosure.

FIG. 6 is a block diagram illustrating an example communications network having an automated call detection and processing system in accordance with various aspects and embodiments of the subject disclosure.

FIG. 7 is a block diagram illustrating an example automated call detection and processing system in accordance with various aspects and embodiments of the subject disclosure.

FIG. 8 and FIG. 9 illustrate example graphical user interfaces (GUIs) in which a called party user equipment displays options to a user for managing robocalls directed at the called party user equipment, in accordance with various aspects and embodiments of the subject disclosure.

FIG. 10 illustrates an example method for performing operations that facilitate automated call detection, authentication, and processing in accordance with various aspects and embodiments of the subject disclosure.

FIG. 11 illustrates an example device operable to facilitate performance of operations related to automated call detection, authentication, and processing in accordance with various aspects and embodiments of the subject disclosure.

FIG. 12 illustrates an example of a machine-readable storage medium comprising executable instructions that, when executed by a processor, facilitate performance of operations related to automated call detection, authentication, and processing in accordance with various aspects and embodiments of the subject disclosure.

FIG. 13 illustrates a block diagram of an example computer that can be operable to execute processes and methods in accordance with various aspects and embodiments of the subject disclosure.

FIG. 14 illustrates a block diagram of an example mobile device that can be operable to execute processes and methods in accordance with various aspects and embodiments of the subject disclosure.

### DETAILED DESCRIPTION

The subject disclosure is now described with reference to the drawings, wherein like reference numerals are used to refer to like elements throughout. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings. In the following description, for purposes of explanation, numerous specific details are set forth to provide a more thorough understanding of the subject disclosure. It might be evident, however, that the subject disclosure can be practiced without these specific details. In other instances, well-known structures and devices are shown in block diagram form to facilitate describing the subject disclosure.

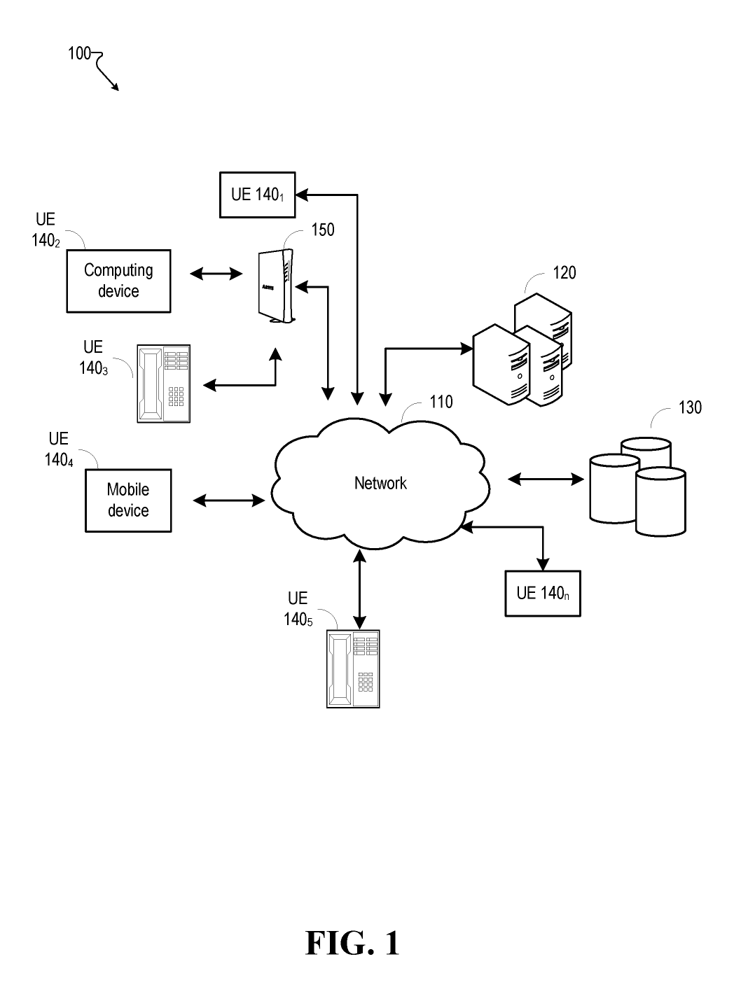

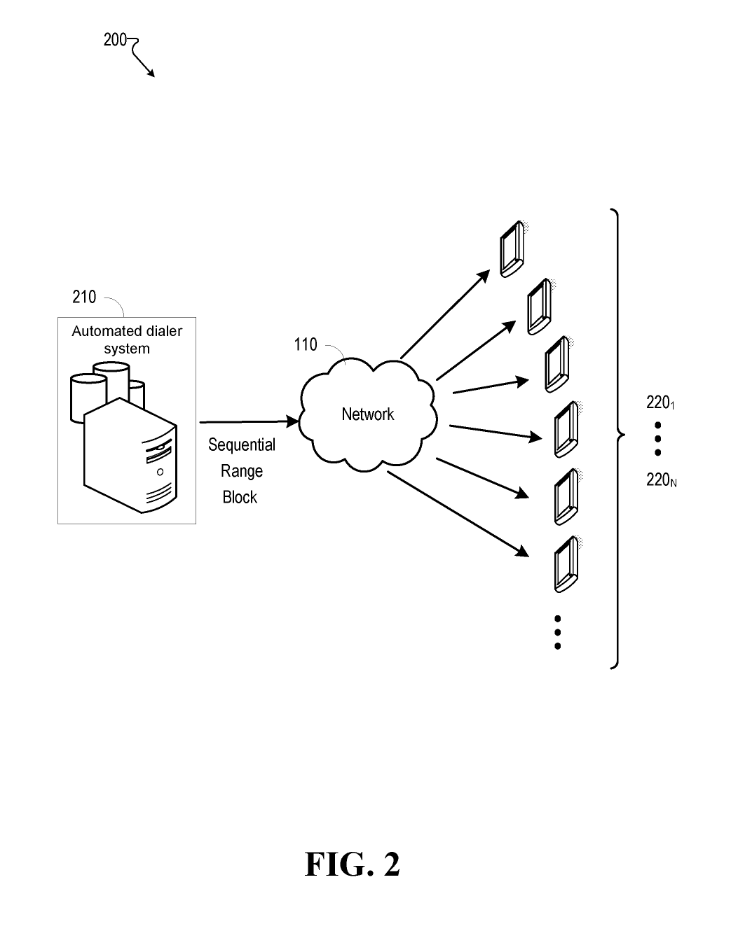

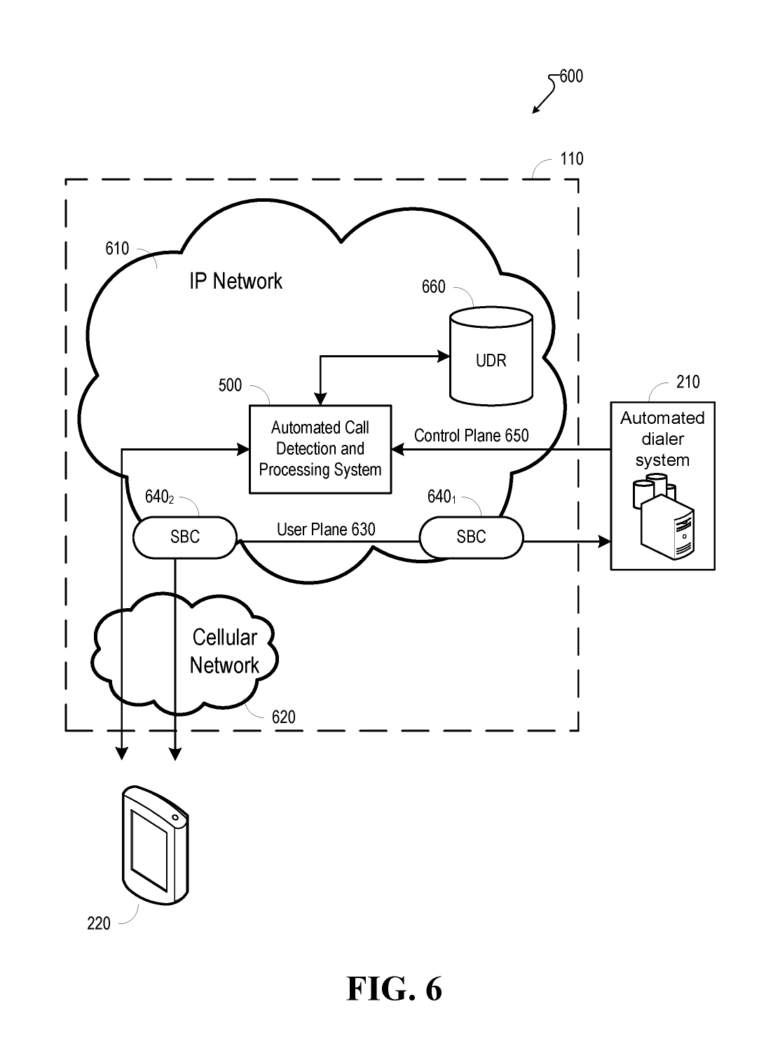

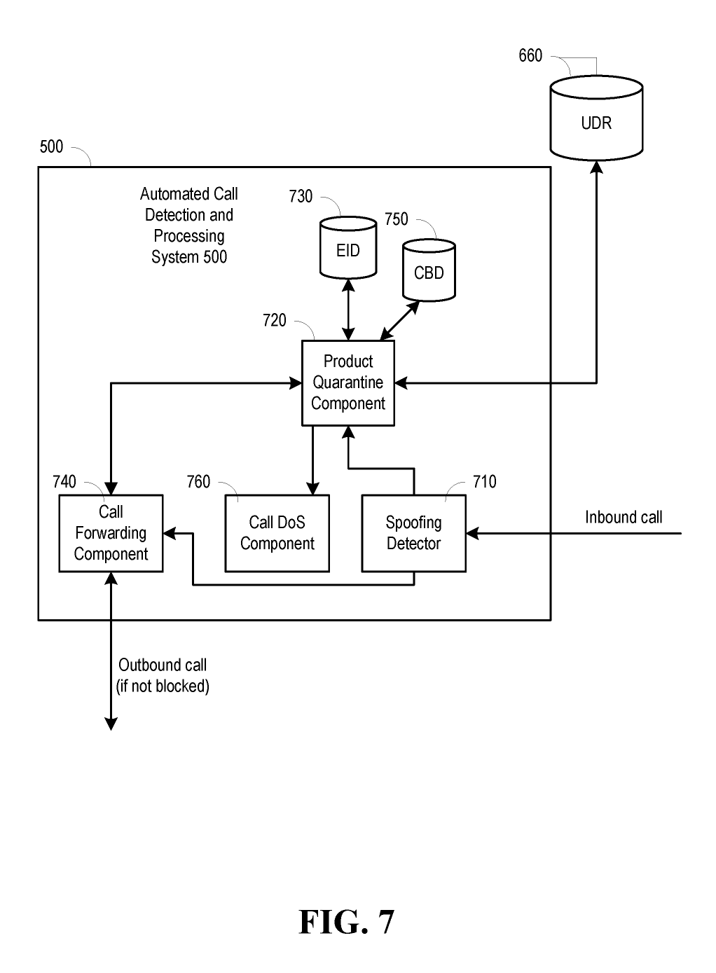

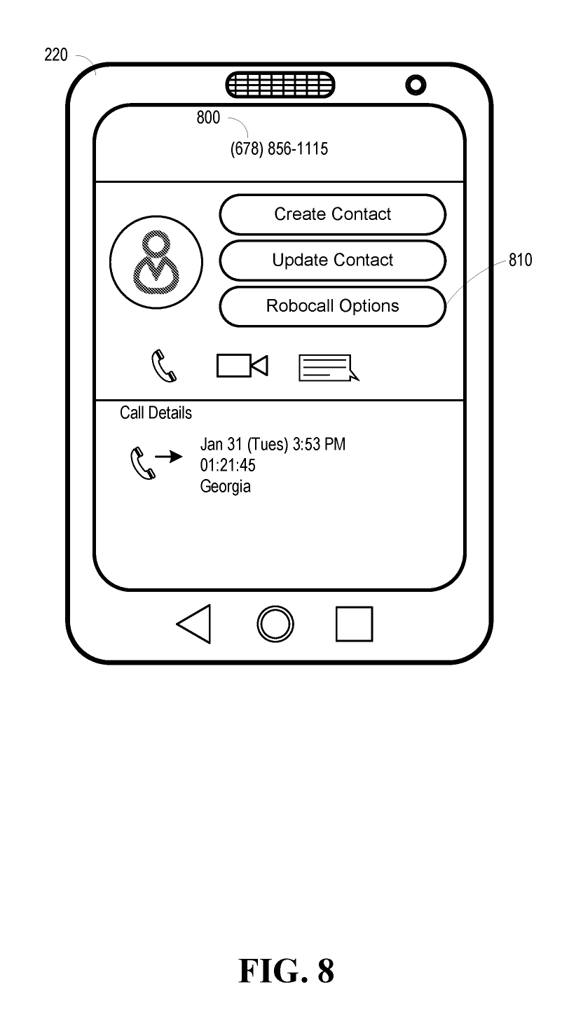

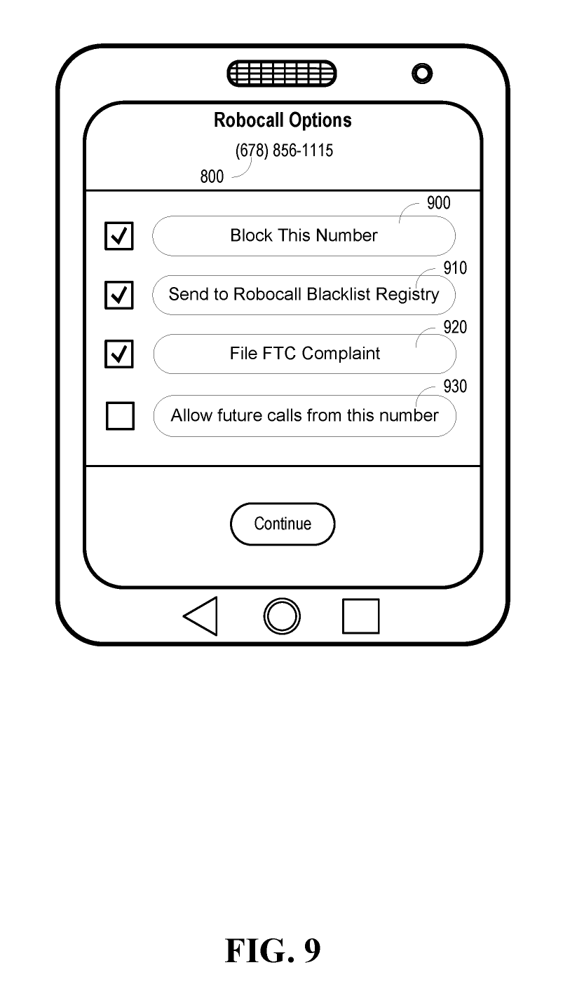

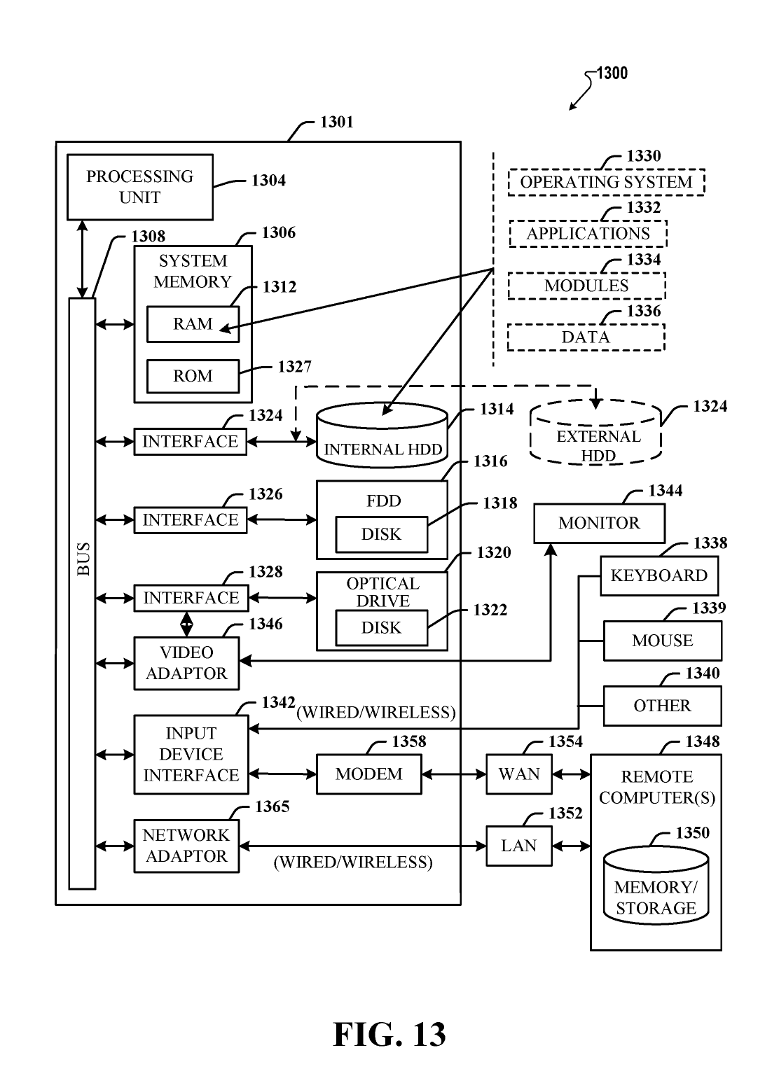

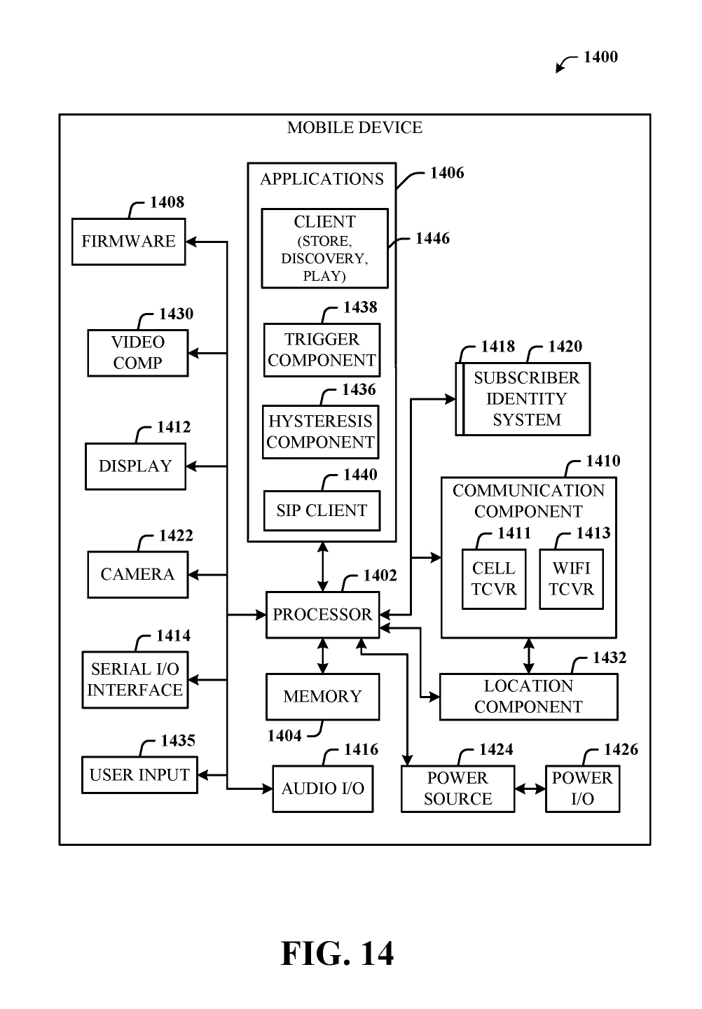

The subject disclosure of the present application describes systems and methods (comprising example computer processing systems, computer-implemented methods, apparatus, computer program products, etc.) for processing a call. The methods (e.g., processes and logic flows) described in this specification can be performed by devices comprising programmable processors that execute machine-executable instructions to facilitate performance of the operations described herein. Examples of such devices are described in the figures herein (for example, FIG. 1, FIG. 2, FIG. 6, FIG. 7, FIG. 8, and FIG. 9), and can comprise circuitry and components as described in FIG. 13 and FIG. 14. Example embodiments and components can take the form of an entirely hardware embodiment, an entirely software embodiment, or an embodiment combining software and hardware aspects.

Example embodiments are described below with reference to block diagrams and flowchart illustrations of methods, apparatuses, and computer program products. Steps of the block diagrams and flowchart illustrations support combinations of mechanisms for performing the specified functions, combinations of steps for performing the specified functions, and program instructions for performing the specified functions. Example embodiments may take the form of web, mobile, wearable computer-implemented, computer software. It should be understood that each step of the block diagrams and flowchart illustrations, combinations of steps in the block diagrams and flowchart illustrations, or any functions, methods, and processes described herein, can be implemented by a computer executing computer program instructions. These computer program instructions may be loaded onto a general-purpose computer, special purpose computer, combinations of special purpose hardware and other hardware, or other programmable data processing apparatus. Example embodiments may take the form of a computer program product stored on a machine-readable storage medium comprising executable instructions (e.g., software) that, when executed by a processor, facilitate performance of operations described herein. Any suitable machine-readable storage medium may be utilized including, for example, hard disks, compact disks, DVDs, optical data stores, and/or magnetic data stores.

The present application describes systems and methods relating to an automated call detection and processing system 500 comprising one or more processors and one or more memories that can store executable instructions that, when executed by a processor, facilitate performance of identifying, authenticating, and processing automated calls, wherein the executable instructions can be comprised of one or more software modules.

FIG. 1 is a diagram illustrating an example of system 100 in which a user equipment can access on-line services provided through one or more server devices having access to one or more data stores, or can make phone calls from a device owned by a calling party identity to a device owned by a called party identity. The system 100 can comprise one or more computer networks 110, one or more servers 120, one or more data stores 130 (each of which can contain one or more databases of information), and one or more user equipment (“UE”) 140_{1-N}. The servers 120 and user equipment 140, which can be computing devices as described in FIG. 13 and FIG. 14, can execute software modules that can facilitate various functions, methods, and processes described herein.

In example embodiments, the one or more computer networks 110 (network 110) can be operable to facilitate communication between the server(s) 120, data store(s) 130, and UEs 140. The one or more networks 110 may include any of a variety of types of wired or wireless computer networks such as a cellular network, private branch exchange (PBX), private intranet, public switched telephone network (PSTN), plain old telephone service (POTS), satellite network, WiMax, data over cable network (e.g., operating under one or more data over cable service interface specification (DOCSIS)), or any other type of computer or communications network. The communications networks can also comprise, for example, a local area network (LAN), such as an office or Wi-Fi network.

Referring to FIG. 1, the network 110 can be a cellular network employing various cellular technologies and modulation schemes to facilitate wireless radio communications between devices. For example, network 110 can operate in accordance with a UMTS, long term evolution (LTE), high speed packet access (HSPA), code division multiple access (CDMA), time division multiple access (TDMA), frequency division multiple access (FDMA), multi-carrier code division multiple access (MC-CDMA), single-carrier code division multiple access (SC-CDMA), single-carrier 1-DMA (SC-FDMA), orthogonal frequency division multiplexing (OFDM), discrete Fourier transform spread OFDM (DFT-spread OFDM) single carrier FDMA (SC-FDMA), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, and resource-block-filtered OFDM. However, various features and functionalities of system 100 are particularly described wherein the devices (e.g., the UEs 102 and the network device 104) of system 100 are configured to communicate through wireless signals using one or more multi-carrier modulation schemes, wherein data symbols can be transmitted simultaneously over multiple frequency subcarriers.

In example embodiments, network 110 can be configured to provide and employ 5G wireless networking features and functionalities. 5G wireless communication networks are expected to fulfill the demand of exponentially increasing data traffic and to allow people and machines to enjoy gigabit data rates with significantly reduced latency. Compared to 4G, 5G can support more diverse traffic scenarios. For example, in addition to the various types of data communication between conventional UEs (e.g., phones, smartphones, tablets, PCs, televisions, internet enabled televisions, etc.) supported by 4G networks, 5G networks can be employed to support data communication between smart cars in association with driverless car environments, “internet of things” (IoT) devices, as well as machine type communications (MTCs). Considering the drastically different communication resources of these different traffic scenarios, the ability to dynamically configure waveform parameters based on traffic scenarios while retaining the benefits of multi-carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to improved spectrum utilization for 5G networks.

To meet the demand for data centric applications, features of proposed 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example; several hundreds of thousands of simultaneous connections to be supported for massive sensor deployments; improved coverage, enhanced signaling efficiency; reduced latency compared to LTE.

The upcoming 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 10 millimeters to 1 millimeter, and these mmWave signals experience severe path loss, penetration loss, and fading. The upcoming 5G access network can also employ an architecture in which a user plane and control plane are separate, wherein complex control plane functions are abstracted from forwarding elements, simplifying user plane operations by relocating control logic to physical or virtual servers.

Still referring to FIG. 1, the communications network 110 can comprise a fixed-packet network. The fixed packet network can be a broadband network using internet protocol (IP) to deliver video, voice, and data. An example of such a network is a cable television (CATV) infrastructure implementing the data over cable service interface specification (DOCSIS) and PacketCable standards, which allow a multiple service operator (MSO) to offer both high-speed internet and voice over internet protocol (VoIP) through an MSO's cable infrastructure. In some implementations, the fixed packet network can have headend equipment such as a cable modem termination system (CMTS) that communicates through one or more hybrid fiber coax (HFC) networks with user premises equipment such as a cable modem or embedded multimedia terminal adapter (EMTA) (see below). The fixed packet network can also comprise networks using asynchronous transfer mode (ATM), digital subscriber line (DSL), or asymmetric digital subscriber line (ADSL) technology. These networks have typically been provided by telephone companies. ATM and DSL/ADSL equipment can be located at an exchange or central office, and can include integrated DSL/ATM switches, multiplexers such as digital subscriber line access multiplexers (DSLAMS), and broadband remote access servers (B-RAS), all of which can contribute to the aggregation of communications from user equipment onto a high-capacity uplink (ATM or Gigabit Ethernet backhaul) to internet service providers (ISPs). Transmission media connecting the central office and user equipment can include both twisted pair and fiber.

The network 110 can also comprise a one or more satellite networks, which can enable the exchange of voice, data, and video. In addition to television programming services, satellite networks, such as a DBS (Direct Broadcast Satellite) system, operated by DBS broadcast satellite providers (e.g., Dish Networks, DIRECTV, HughesNet), can be operable to enable high speed internet and voice services.

The network 110 can also comprise a POTS network that supports the delivery of voice services employing analog signal transmission over copper loops.

Referring to FIG. 1, servers 120 can be operable to send via network 110 executable code capable of generating graphical user interfaces (GUIs) that a user identity can interact with to facilitate the provision of such on-line data, or voice services. The GUIs can be, for example, a webpage that can be displayed (and interacted with) on a user equipment 140. Modules comprising executable instructions that, when executed by a processor of the server 120, facilitate performance of operations, such as the exchange of data or the exchange of voice (e.g., a soft phone), can be stored on a memory device of the server 120 (or a memory device connected to the server 120).

The data stores 130 can comprise physical media for storing information, housed within the one or more servers 120, peripherally connected to the one or more servers, or connected to the servers 120 through one or more networks. For example, the storage device can be connected to the processor of a server, via, for example, a communications medium such as a bus (e.g., SATA, eSATA, SCSI, flash, or the like). As another example, data stores 130 can be peripheral devices, set up as a redundant array of independent disks (RAID) array, a storage area network (SAN), or network attached storage (NAS). The data stores can comprise magnetic memory, such as a hard drive or a semiconductor memory, such as Random Access Memory (RAM), Dynamic RAM (DRAM), non-volatile computer memory, flash memory, or the like. The memory can include operating system, administrative, and database program modules that support the methods and programs disclosed in this application.

Referring to FIG. 1, user equipment 140 can be, for example, a tablet computer, a desktop computer, or laptop computer, a cellular enabled laptop (e.g., comprising a broadband adapter), a handheld computing device, a mobile phone, a telephone, a smartphone, a tablet computer, a wearable device, a virtual reality (VR) device, a heads-up display (HUD) device, an IoT device, and the like.

In example embodiments, a customer premises equipment (CPE) 150 can provide access for the UE (e.g., UE 140₂) to the one or more networks 110. The CPE 150 can comprise a broadband access modem (e.g., cable modem, DSL modem, Wi-MAX modem, satellite modem). The CPE 150 can also comprise a gateway device (also referred to as a residential gateway, home gateway, set top gateway) that processes video, voice packets, and data packets and serves as a broadband connectivity point for various devices (e.g., video set-top boxes, computers, mobile devices, telephones). The UE (e.g., UE 140₂) can be connected to the CPE device via, for example, an Ethernet interface, or a wireless access point device (which can be embedded within the CPE device, or connected to the CPE device as a peripheral device), which can operate in accordance with the IEEE 802.11 family of standards.

For voice services, a computer (or computing device) connected to a network 110 that executes VoIP software can allow for voice calls to be made via a computer application (i.e., a “softphone” such as that offered by Skype). The VoIP software can be provided by one or more servers 120. Additionally, the CPE 150 can be embedded with a VoIP adapter, through which a telephone 140₃ can connect (e.g., via an RJ-11 phone jack) and make voice calls. Examples of such devices that support voice and data communications are referred to as a telephony modems, embedded multimedia terminal adapters (EMTAs), digital voice modems, voice data modems, voice and internet modems, and the like. In other embodiments, a VoIP adapter can be peripheral to the broadband modem, and the telephone can connect to that VoIP adapter (e.g., an adapter provided by Vonage, Ooma, etc.). In other embodiments, a VoIP adapter can be connected to a computer, for example, via its universal serial bus (USB) port (e.g. an adapter provided by magicJack).

Referring to FIG. 1, a UE 140₄ can be a mobile device used to make and accept voice calls, including a cellular phone, as well as a tablet with a cellular adapter. The mobile device can be operative to make voice calls through the network 110 to other communications devices. Further details describing a mobile device are described below in FIG. 14 below.

The UE 140 can also be a POTS telephone 140₅ connected to the network 110.

FIG. 2 is a diagram that illustrates an example networking environment in which a typical automated dialer 210 can be operable to initiate automated calls (e.g., robocalls). Typically, an automated dialer 210 (also referred to as an automated dialer system, automated calling system, robocaller, or predictive dialer) is used in business to consumer (B2C) applications, and can be one or more computers operable to run modules that, when executed, automatically makes voice calls, which can be made simultaneously or in rapid succession, to a plurality of call destinations. The automated dialer 210 can be for example, a UE having a broadband connection and operable to make VoIP calls (e.g., UE 140₂), and the modules can be locally stored or provided by one or more servers (e.g., servers 120). The automated dialer 210 can make voice calls to called party UEs 220_{1-N}, which can be one or more UEs 140 (e.g., a cellular phone, a VoIP phone, a POTS phone, etc.) that are operable to answer voice calls. After connection with a called party UE 220 (one of the plurality of called party UEs 220_{1-N}) the automated dialer 210 plays a pre-recorded message to either the called party identity, or a voicemail system if the called party identity does not answer. Almost all robocalls originate through a VoIP network. Example vendors of automated dialers and predictive dialers can include Voice2Phone, VoiceShot, Voicent, CallFire and Five9.

Intercepting and blocking unwanted automated calls can be a challenge, in large part because some of these calls are actual public service announcements, such as from the weather service, school system, public safety departments, etc. In other example use cases, large organizations, for example a large religious congregation, might use robocalls as an effective way to distribute pre-recorded messages. There are many ways to mask a call as a legitimate call by “spoofing” the originating number, such that the automated call appears to a blocking system, as well as called party identities, as coming from a legitimate source. Additionally, some called party identities might desire to continue to receive robocalls for which they have an interest.

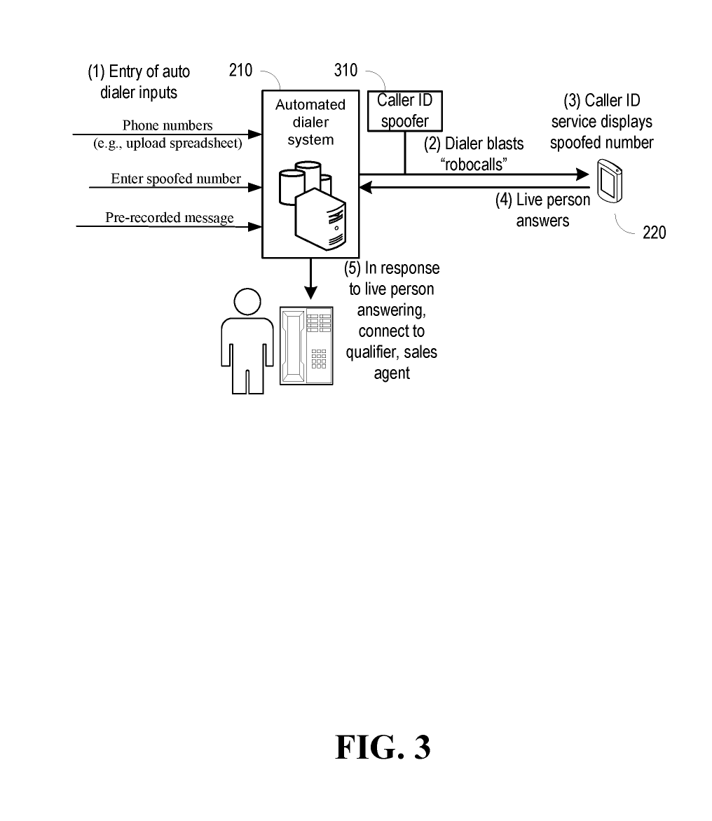

In FIG. 3, a typical automated dialer 210 operated by marketing identities, can at transaction (1) receive automated dialer inputs. An automated dialer input can comprise a plurality of target phone numbers corresponding to called party UEs (e.g., UEs 220_{1-N}). The phone numbers might have been collected from called party identities, who might have provided their phone numbers in response to surveys, purchases, etc. A typical automated dialer 210 allows input of phone numbers manually, as well by uploading a spreadsheet, or some other type of file, having the phone numbers. An automated dialer input can also comprise a “spoofed” number. A marketing identity can enter a number that the marketing identity wants to appear on a called party UE 220's caller ID display, instead of the originating number of the automated call (e.g., number of the calling party, also known as an “A number”). An automated dialer input can also comprise a pre-recorded message (e.g., an audio file) which can be input by uploading or otherwise transferring the file to the automated dialer 210. The pre-recorded message is played by the automated dialer 210 when the automated call is answered by the called party UE 220 (or its answering service).

At transaction (2) of FIG. 3, the automated dialer 210 can make a multitude of voice calls directed at called party UEs 220_{1-N}. For illustrative purposes, only one called party UE 220 is shown. The automated dialer 210, with its own spoofing module, or through a caller ID spoofing system 310 provided by another server, can be operable to transmit the inputted spoofed number with the call in place of the originating number that would otherwise show up on a caller ID display. Thus, each call would have associated with it the spoofed caller ID number that was entered at transaction (1). The calls that are made by the auto-dialer can be directed to phone numbers input into the automated dialer 210 at transaction (1), as well as numbers selected by a predictive dialer, which can include numbers in a sequence (dialing numbers in sequential order), a block, or a range. Certain blocks of phone numbers are meant for certain businesses (for example, a block of numbers can be reserved for hospitals), and as such, numbers in particular blocks might be targeted by automated dialers. Numbers in a range are like numbers that are sequentially dialed, but are certain ranges of numbers within a sequence. Automated dialers can sometimes use ranges of numbers to avoid sequence dialing detecting algorithms that attempt to block automated calls (e.g., calling 0000 to 0500 might trigger an alert, but selecting a range of numbers within that sequence might avoid detection). Another characteristic of automated calls might be that the calls were dialed simultaneously, or in rapid succession with a short time-frame between each call (e.g., no pauses, or no significant pauses between calls).

At transaction (3), when a called party UE 220 is dialed, a caller ID service might display the number to the called party identity via the called party UE 220's GUI. If an automated call contained a spoofed number, the spoofed number might appear.

A typical automated dialer 210 can be further operative to, in response to a called party identity answering an automated call, connect the called party UE 220 with a qualifier, wherein the qualifier might be an interactive voice response system (IVR) that prompts the called party identity to select or enter information. If certain information entered by the called party to the qualifier indicates that the called party identity's profile matches a profile of the marketing identity's target audience, the automated dialer 210 can be operative to connect the called party UE 220 with a sales agent.

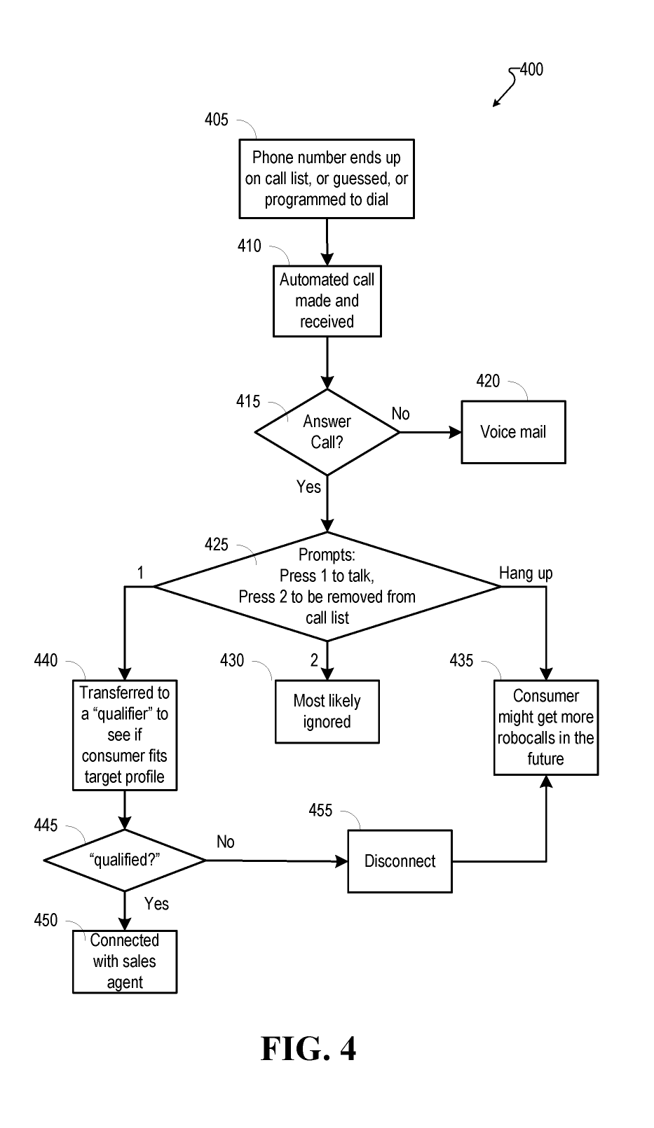

FIG. 4 illustrates a typical response and experience of a user identity to an automated call. At step 405, the called party identity might have responded to a survey, signed up for an event, filled out an on-line application, or gave approval for a particular service or application to access his or her contact information, wherein the contact information comprises the called party identity's phone number. The called party identity's phone number might eventually wind up on a marketing entity's phone list.

At step 410, the called party identity might receive a phone call (e.g., an incoming call) on his or her phone (e.g., called party UE 220). If the phone is operable to display caller ID information, the calling party's number and name might show up on the caller ID display. However, this number and information might be a spoofed number and spoofed name. The number might have, for example, an area code that is the same as the area code of the called party identity's phone number, such that the called party identity might believe that the calling party is a local identity, such as a nearby friend or neighbor, thereby increasing the probability that the called party identity will answer the automated call.

At step 415, the called party identity can decide whether to answer the call. In response to the user not taking the call, at step 420 the call might be directed to the called party identity's voice mail, in which case the automated dialer 210 plays the prerecorded message related to the subject matter of the sales call.

At step 425, if the called party identity answers the call, the automated dialer 210 plays a prerecorded message briefly describing the goods or services being sold, and then prompts the called party identity to either push a button to speak to a representative or push a button to be removed from the marketer's phone list.

At step 430, in response to a called party identity's selection to be removed from the marketer's phone list, the called party identity's selection will most likely be ignored. If the called party entity at step 435 decides to hang up (e.g., end the call), the called party might still get more automated calls in the future. If the called party identity responds by indicating a desire to speak with a representative, the automated dialer 210 might at step 440 connect the user with a qualifier, which can prompt the called party identity to select or enter information. If certain information entered indicates that the called party identity's profile matches a profile of the marketing identity's target audience, the called party identity at step 450 is transferred to a sales agent. If the called party identity's profile does not match, then at step 455 the automated dialer 210 can inform the called party identity that his or her profile does not qualify them for the offer, and then disconnect. After disconnection, as was the case at step 435, the called party identity might still get another automated call in the future. As such, with automated calls, the experience of a called party identity can range from being annoyed, to being angry and frustrated.

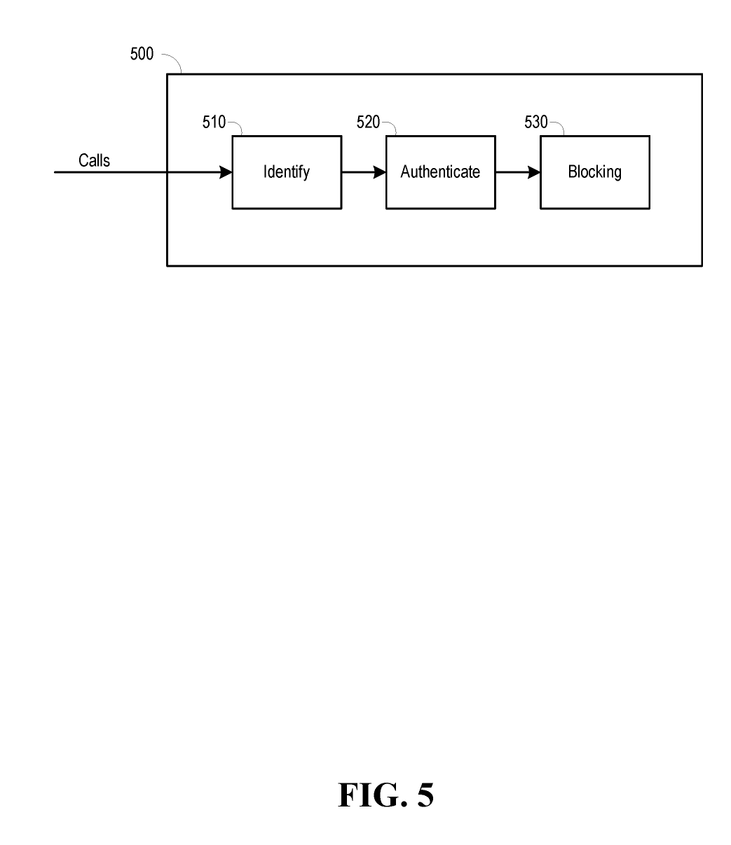

Referring to FIG. 5, in example embodiments of the present application described herein, an automated call detection and processing system 500 comprising one or more processors and one or more memories that can store executable instructions that, when executed by a processor, facilitate performance of identifying, authenticating, and blocking of automated calls, wherein the executable instructions can be comprised of one or more software modules. The system 500 can be implemented as a network device, which can comprise one or more servers, one or more data stores, or even within a communications switch. Regarding the operations, at the identification stage 510, the system can determine whether the originating number is a number that has been spoofed. While there might be legitimate reasons for a calling party's use of spoofed numbers (e.g., a police investigation in which an investigator uses a pretense), the likelihood that an automated call is vexatious, malicious, or fraudulent is higher when the calling party is spoofing its number. In response to a determination that the originating number has been spoofed, the system can determine whether the characteristics of the call are consistent with those of an automated call, for example exhibit certain patterns or behaviors (e.g., by determining whether the calls coming from the originating number are in a sequence, a range, or a block, or whether the calls were dialed simultaneously, or in rapid succession with a short time-frame between each call).

At the authentication stage 520, in response to a determination that the call is an automated call, the system 500 can be operative to determine whether the automated call originates from certain authorities approved for legitimate automated calls (e.g., emergency authorities, NSA, political fund raising, etc.). It can also be determined whether the originating number is in a database comprising crowdsourced or investigated blacklisted numbers (e.g., known to be a source of malicious or vexatious automated calls), or whether the originating number is in a database comprising the called party's personalized black list.

At the blocking stage 530, in response to a determination during the authentication process that the automated call should be blocked, the system 500 can be operative to block the call (e.g., terminate the call), or alternatively, divert the call with to a voice messaging system that answers with a “do not call.”

FIG. 6 depicts an example environment 600 in which the automated call detection and processing system (e.g., call detection and processing system 500) can be implemented. The environment can comprise an automated dialer (e.g., automated dialer 210) that directs automated calls thought a communications network (e.g., network 110) to one or more called party UEs (e.g., UEs 220_{1-N}). For illustrative purposes, only one called party UE 220 is shown.

In example embodiments, as shown in FIG. 6, the network can comprise an IP network 610, which can be a fixed packet network, and a cellular network 620. The call can be processed through a user plane and a control plane, wherein each plane can be conceptualized as different areas of communications operations. Each plane carries a different type of traffic and can be implemented as overlay networks that runs independently on top of another one, although supported by its infrastructure. The user plane (sometimes known as the data plane, forwarding plane, carrier plane, or bearer plane) carries the network user traffic, and the control plane carries signaling traffic. In example embodiments, the planes can be implemented in the firmware of routers and switches. Software-defined networking (SDN) decouples the data and control planes, removes the control plane from network hardware, and implements the control plane in software instead, which enables programmatic access and, as a such, can make network administration much more flexible and dynamic A network administrator can shape traffic from a centralized control console without having to touch individual switches. The administrator can change any network switch's rules when necessary—prioritizing, de-prioritizing or even blocking specific types of packets.

With respect to FIG. 6, the user plane 630 can carry the network user traffic (e.g., voice traffic) between the automated dialer 210 and the called party UE 220. In the example embodiment shown, the communications through the user plane can comprise session border controllers (SBCs) 640₁ and 640₂ at the edge of the IP network 610, wherein an SBC can be hardware or software applications that oversees the manner in which calls (e.g., sessions) are initiated (set up), conducted, and terminated (or torn down) on a voice over internet protocol (VoIP) network, including for both telephone calls or other interactive media communications. An SBC can act as a router, allowing only authorized sessions to pass through the connection point (e.g., border). The SBC can also monitor the quality of service (QoS) status for calls, apply QoS rules, prioritized calls (e.g., emergency calls), and function as a firewall by identifying threats. Additionally, SBCs often provide measurement, access control, and data conversion for the calls they control. Typically, SBCs are deployed on both the carrier and enterprise sides of the connection.

In FIG. 6, the automated call detection and processing system 500 can operate at the control plane level, wherein the control plane 650 carries signaling traffic (e.g., control packets), including the control packets between automated dialer 210 and called party UE 220. The automated call detection and processing system 500, described in further detail below with respect to FIG. 7, can be operative to facilitate the identifying, authenticating, and blocking of automated calls. With respect to authentication, as mentioned above in FIG. 5 and its corresponding text, a called party identity, after being called by an automated dialer, can select for entry the originating number to a database comprising the called party's personalized black list. In example embodiments, the called party identity's entry can be stored with a called party identity's profile in a user data registry (UDR) 660, which can contain a multitude of profiles of different called party identities (e.g., crowdsourced from other parties who have been auto dialed). Other user data registries can comprise a home subscriber server (HS S) database, which contains subscription-related information (subscriber profiles), performs authentication and authorization of the callers, and provides information about a subscriber's location and IP information. Other user data registries can comprise a home location register (HLR), or an authentication centre (AuC).

FIG. 7 illustrates a block diagram of an example automated call detection and processing system 500 that facilitates operations comprising the identification, authentication, and blocking of automated calls. The system 500 can comprise a spoofing detector 710, for facilitating the identification of automated calls. The spoofing detector 710 can receive incoming calls, and determine whether an originating number associated with the call matches a caller ID number associated with the call. If an automated dialer (e.g., automated dialer 210) used a caller ID spoofer (e.g., caller ID spoofer 310) to present a caller ID number different from the originating number of the called party, then the likelihood of the call being a vexatious or malicious automated call increases. In a typical communications system, one or more switches, which can reside within a switching center, performs the switching necessary to interconnect calls between user devices. When a calling party contacts a called party, a request from the user's telephone is sent to network (e.g., network 110) to make a connection with the called party. As is known in the art, the number from which the call originates (e.g., the originating number) is referred to as the “A number” and the called party's number is termed the “B number.” Typically, a “B number analysis” is performed whereby a switch uses the A number and B number to determine the better path to route the call. Although a caller ID number can be spoofed, the underlying A number of the call remains and is not only used for routing purposes, but is also associated with the calling party's account for billing purposes (which can be stored in, for example, a UDR 660).

In example embodiments in accordance with the present application, the functionality of the automated call detection and processing system 500, or in some example embodiments the spoofing detector 710, can reside within a switch. The spoofing detector can be operable to, in conjunction with the switch's B number analysis, use the A number to determine whether the A number matches the caller ID number of the call. If the caller ID number associated with the call does not match up with the calling party's originating number, then this is an indication that the originating number has been spoofed. In response to a determination that the originating number has been spoofed, the system 500 can perform further analysis to determine whether the call is one of a group of calls consistent with calls made by an automated dialer. Automated dialers typically place an exorbitant number of calls. One characteristic of auto dialed calls are that there are no significant pauses between the calls, or that the calls might be simultaneously dialed. As another example, calls coming from an automated dialer are in a sequence, a range, or a block (as mentioned above). The system 500 can determine, based on an aggregate number of calls having the originating number, whether calls associated with that originating number exhibit the characteristics of automated calls.

Still referring to FIG. 7, in response to a determination by the spoofing detector that the call is one of a group of calls from the automated dialer that exhibit the characteristics of automated calls, a profile quarantine component 720 can processes anomalous profiles that can use more examination and approval. It can determine whether the originating number corresponds to a number of a legitimate calling party, or whether the originating number is a blacklisted number (i.e., determined to belong to a party that originates vexatious or malicious robocalls) by querying one or more databases, which may reside in one or more data stores. The profile quarantine component 720 can query an entity identity database EID 730, wherein the EID contains entries for legitimate government identities or official identities that are allowed to initiate robocalls for various reasons such as public safety, national security, and political polling. If the originating number matches an entry in this database, the call can be directed to a call forwarding component 740 which forwards the call to be connected with the intended called party UE.

Still on FIG. 7, if the originating number does not match an entry in the EDI 730, the profile quarantine component 720 can be further operable to query a caller blacklisted database CBD, which can contain entries relating to identified and verified blacklisted profiles. The CBD 750 can be a dynamic database that is continuously updated with the originating numbers from which automated calls are made. The updates can be based upon the submissions of called party identities indicating that the call is an unwanted robocall (e.g., crowdsoured). The originating number can be used to determine the name of the calling party identity. The calling party identity can be determined, for example, by querying the UDR 660 to determine the name of the called party associated with the originating number, as the UDR 660 can contain not only information related to the called party, but also information related to the calling party. A database entry for that calling party identity can have associated with it numerous originating numbers. Each originating number can be associated with the calling party identity, and each calling party identity can have numerous originating numbers associated with it.

As an example, a determination can be made that the originating number is associated with the Ajax Marketing Company, and further that the Ajax Marketing Company might have five originating numbers that it has been using to make automated calls. Each time a called party identity reports one of the originating numbers as being a robocall to be blocked, an entry can be created in the profile for Ajax Marketing Company. If the aggregate number of entries of originating numbers associated with Ajax Marketing Company reaches a certain threshold number (e.g., 200 entries), then future calls from Ajax Marketing Company, regardless of which automated number Ajax Marketing Company uses to dial, can result in automated calls from Ajax Marketing Company being blocked.

The CBD 750 can also store entries for originating numbers associated with called parties that have been subject to criminal investigation, or that have been added based on consumer complaints to the federal communications commission (FCC).

Additionally, the profile quarantine component 720 can query a UDR (e.g., UDR 660) to determine whether the originating number is associated with an entry stored in the UDR 660 under the called party identity's profile. This entry can be based upon the submissions of the called party UE 220 indicating that the call is an unwanted robocall.

Still referring to FIG. 7, in response to a determination by the product quarantine component 720 that the originating number is associated with a blacklisted entry that is in either in the CBD 750 or in the URD 660, the product quarantine component 720 can communicate with a call denial of service (CDoS) component 760 that handles blocking of the call. The system 500 can be operative to block the call. The system can also divert the call by connecting it with a voice messaging service that answers with a “do not call” message. An IVR service can also be used to emit a dial tone of “2” signifying to the automated dialer 210 that the called party wishes to be removed from the automated dialer 210's calling list.

In response to a determination by the product quarantine component 720 that the originating number does not appear in any blacklist database (e.g., contained in the CBD 750 or UDR 660), the product quarantine component 720 can communicate with the call forwarding component 740 to process the call and connect the calling party identity with the called party identity. In this situation, a call that had been determined to have been identified by the spoofing detector 710 to be an automated call, and been further investigated by the product quarantine component 720 as not originating from a blacklisted identity, has been allowed to proceed with connection establishment. In some example embodiments, the system 500 can be operative to replace a caller ID number, if spoofed, with the actual originating number of the automated dialer 210. After establishment of this call with the called party UE 220, the called party identity can still block future calls from the calling party. For example, the called party UE 220 can provide the called party identity with options to block the automated call from the calling party, as described below with respect to FIG. 8 and FIG. 9. In response to an indication that the called party wishes to block future calls from the called party initiating the robocall, the called party UE 220 can send a message back to the system 500. The system 500 can store the originating number in a blacklist entry in the CBD 750. As mentioned above, if enough called party identities indicate that they would like to have the number blocked, then at some point (e.g., after reaching a threshold number of indications to block), the originating number, as well as any other originating numbers belonging to the calling party identity associated with the originating number, can be blacklisted. As a result, the next time a call is made by the automated dialer 210, any calls initiated by the calling party identity can be blocked.

Still referring to FIG. 7, additionally, when a called party UE 220 sends a communication back to the system 500 indicating that an originating number should be blocked, the system 500 can also update the called party identity's blacklist, which can be stored as part of the called party's profile in UDR 660, so that future calls to the called party from this originating number can be blocked by the system 500. The system 500 can also be operable to identify the calling party identity, and determine whether other originating numbers belong to the calling party identity; those other originating numbers can also be added to called party identity's blacklist.

FIG. 8 illustrates an example GUI in which a called party UE 220 can be operative to present a called party identity with a prompt to manage options related to the processing of the originating number of an automated call. In response to a determination by the automated call detection and processing system 500 to process an automated call and connect the calling party identity with the called party identity, a called party UE 220 might ring to alert a user of the call. The called party identity might answer the call and experience one or more of the steps as shown in FIG. 4. The called party UE 200 can be operable to display a call log entry showing a log entry for the automated call. In response to the called party identity selecting the call log entry, the called party UE 220 can display a GUI as shown in FIG. 8 that shows the called party identity's originating number 800. As mentioned above, system 500 can be operable to replace any spoofed caller ID number with the actual originating number that made the call, but here, the system 500 replaced the spoofed caller ID number with the originating number.

While a typical phone can have options to create a contact for the originating number 800, or update a contact so as to associate the originating number with an existing contact, in example embodiments of the present application, the called party UE 220 can be operable to display a “Robocall Options” button 810. Upon selection of the robocall options button 810, the called party UE 220 can be operable to display the interface show in FIG. 9.

FIG. 9 illustrates an example GUI in which a called party UE 220 can be operative to present a called party identity with several prompts related to options for responding to an automated call.

If the called party identity selects the “block this number” option 900, the called party UE 220 can be operable to send a communication to the automated call detection and processing system 500 indicating that the originating number 800 (e.g., 678-856-1115) should be blocked. The system 500 can also update the called party identity's blacklist, which can be stored as part of the called party's profile in UDR 660 in the network 110, so that future calls to the called party from this originating number can be blocked at the network level, as opposed to the device level. The system 500 can also be operable to identify the calling party identity, and determine whether other originating numbers belong to the calling party identity; those other originating numbers can also be added to called party identity's blacklist.

Still referring to FIG. 9, if the called party identity selects the “Send to Robocall Blacklist Registry,” button 910, the system 500 can respond to the communication to block the originating number 800 by updating the CBD 750, which contains entries based on requests to block from a plurality of called parties. If the called party identity does not believe the automated call to be vexatious or malicious, he or she can choose to block the call, but choose not to send a communication that might result in all future calls from the calling party being blocked.

The called party device 220 can also be operable to display to the called party identity an option to initiate the filing of an FTC complaint regarding the automated call. For example, a user can select a “File FTC Complaint” button 920. After receiving a user input selecting this option, the called party device 220 can automatically present a step-by-step “wizard” interface to obtain information from the called party identity that the FTC typically seeks to obtain when an identity files a complaint regarding robocalls. For example, the first screen might have the categories of “telemarketing—unwanted telemarketing calls on a landline or mobile device”, or “the call in question was a pre-recorded call, commonly known as a robocall” already selected in response to the called party's selection of button 920. The wizard can be operative to enable the called party to input other details as well, as such as the contact date, phone call, how much did the telemarketer ask the consumer identity to pay, how much did the consumer actually pay, how did the consumer respond to the contact, etc.

Still referring to FIG. 9, the called party device 220 can also be operable to display to the called party identity an option to “Allow future calls from this number” 930. A called party identity can select this option so as to “whitelist” the number. In example embodiments, the called party identity's selection can be stored in the network 110 (e.g., in the UDR 660), and the product quarantine component 720 can be operative to query the UDR 660 for future calls from the originating number. Here, the called party identity can choose to receive robocalls, even if other called parties have identified and reported the originating number as a vexatious or malicious robocall.

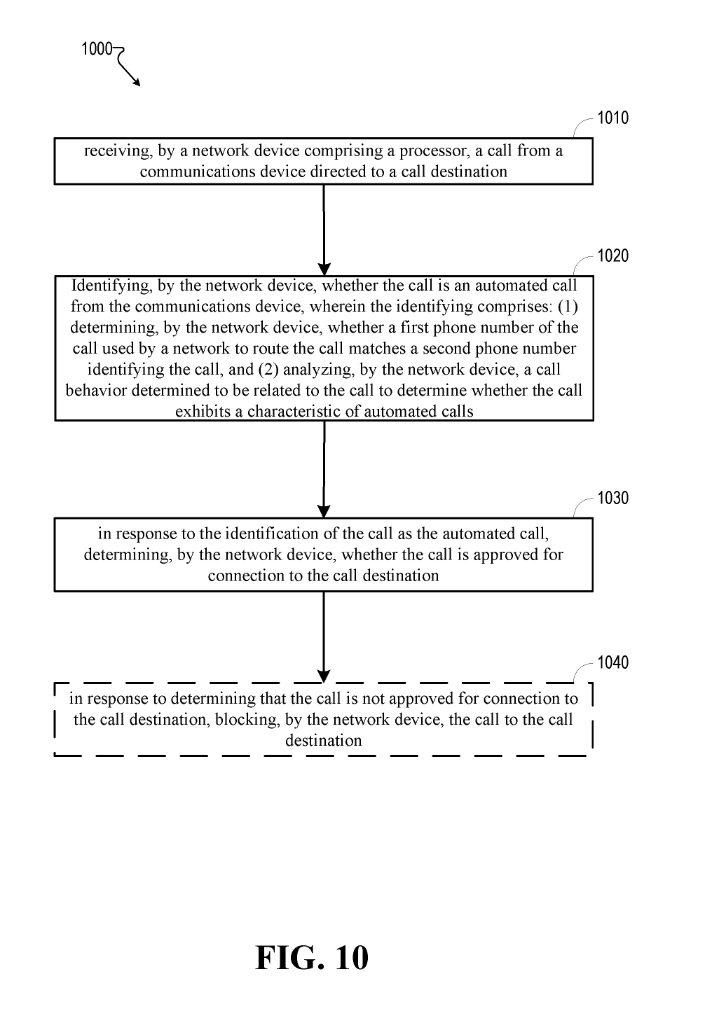

Moving on to FIG. 10, in example embodiments, a method performed by a network device (e.g., a switch, a server, a computer, etc.) comprising a processor can facilitate performance of operations as illustrated in flow diagram 1000 of FIG. 10. As shown at 1010, the operations can comprise receiving a call from a communications device directed to a call destination. The communication device can be an automated dialer (e.g., automated dialer 210), and the call destination can be a called party UE (e.g., called party UE 220).

At step 1020, the operations can comprise identifying the call as an automated call from the communications device. The identifying can comprise determining whether a first phone number of a call used by a network to route the call (e.g., the originating number, or the A number) matches a second phone number identifying the call (e.g., the caller ID number, which may have been spoofed). The identifying can also comprise, in response to a determination that the first and second numbers do not match, analyzing, by the network device, a call behavior determined to be related to the call to determine whether the call exhibits a characteristic of automated calls (e.g., whether the call destination number is a call that is in a sequence, a range, or a block (as mentioned above), thereby exhibiting the characteristic of automated calls).

At step 1030, the operations can comprise, in response to identifying the call as the automated call, determining whether the call is approved for connection to the call destination. In example embodiments, determining whether the call is approved comprises accessing an entity identity data store (e.g., EID 730), comprising a data entry for an entity identity (e.g., the government, severe weather warning services, emergency services, etc.) indicated to be allowed to initiate the automated call and determining whether the call is associated with the data entry. In example embodiments, determining whether the call is approved comprises accessing an entity identity data store (e.g., CBD 750) comprising a data entry for an entity identity that is indicated not to be permitted to initiate the automated call (e.g., a blacklisted calling party) and determining whether the call is associated with the data entry. The data entry stored can be stored at the request of the communications device associated with the call destination (e.g., the called party UE).

Still referring to FIG. 10, the operations further comprise, in response to determining that the call is approved for connection to the call destination, connecting the call to the call destination. The operations can optionally further comprise, in response to determining that the call is not approved for connection to the call destination, blocking the call to the call destination.

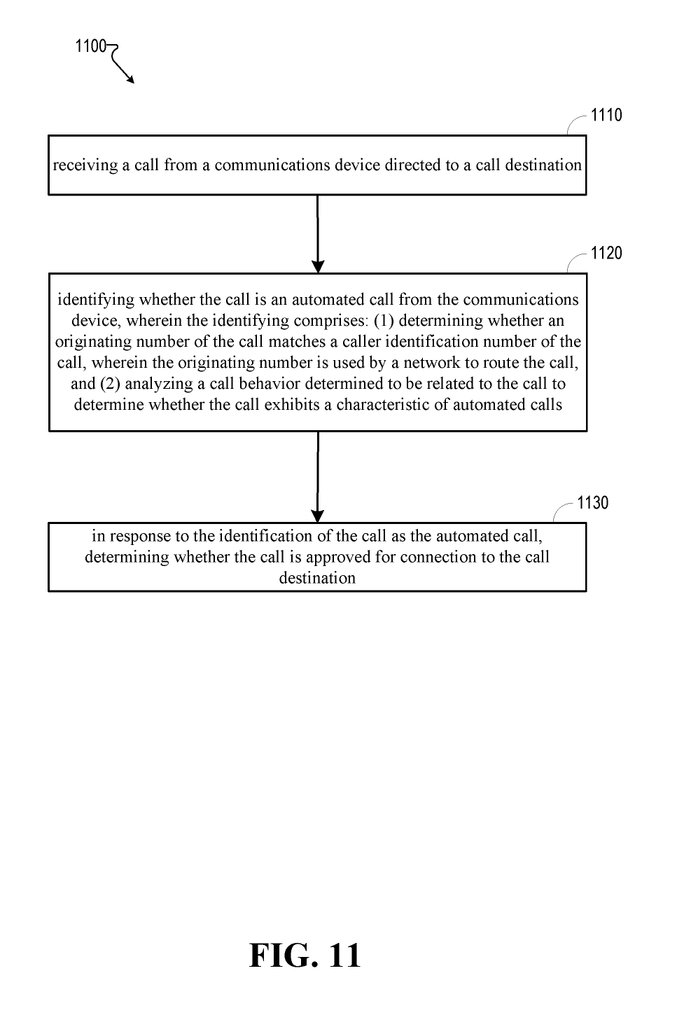

Referring now to FIG. 11, in example embodiments a device (e.g., a switch, network device, computer, etc.), comprising a processor and a memory that stores executable instructions that, when executed by the processor, facilitate performance of operations 1100. The operations 1100 at step 1110 can comprise receiving a call from a communications device (which might be an automated dialer) directed to a call destination (e.g., a called party UE).

The operations 1100 can further comprise, in step 1120, identifying whether the call is an automated call from the communications device, wherein the identifying comprises determining whether an originating number of the call (e.g., an A number) matches a caller identification number of the call (e.g. caller ID number), wherein the originating number is used by a network to route the call, and analyzing a call behavior determined to be related to the call to determine whether the call exhibits a characteristic of automated calls.

Still referring to FIG. 11, the operations 1100 can further comprise, in step 1130, in response to the identification of the call as the automated call, determining whether the call is approved for connection to the call destination. In example embodiments, determining whether the call is approved comprises accessing an entity identity data store (e.g., EID 730), comprising a data entry for an entity identity (e.g., the government, severe weather warning services, emergency services, etc.) indicated to be allowed to initiate the automated call and determining whether the call is associated with the data entry. In example embodiments, determining whether the call is approved comprises accessing an entity identity data store (e.g., CBD 750) comprising a data entry for an entity identity that is indicated not to be permitted to initiate the automated call (e.g., a blacklisted calling party) and determining whether the call is associated with the data entry. The data entry stored can be stored at the request of the communications device associated with the call destination (e.g., the called party UE).

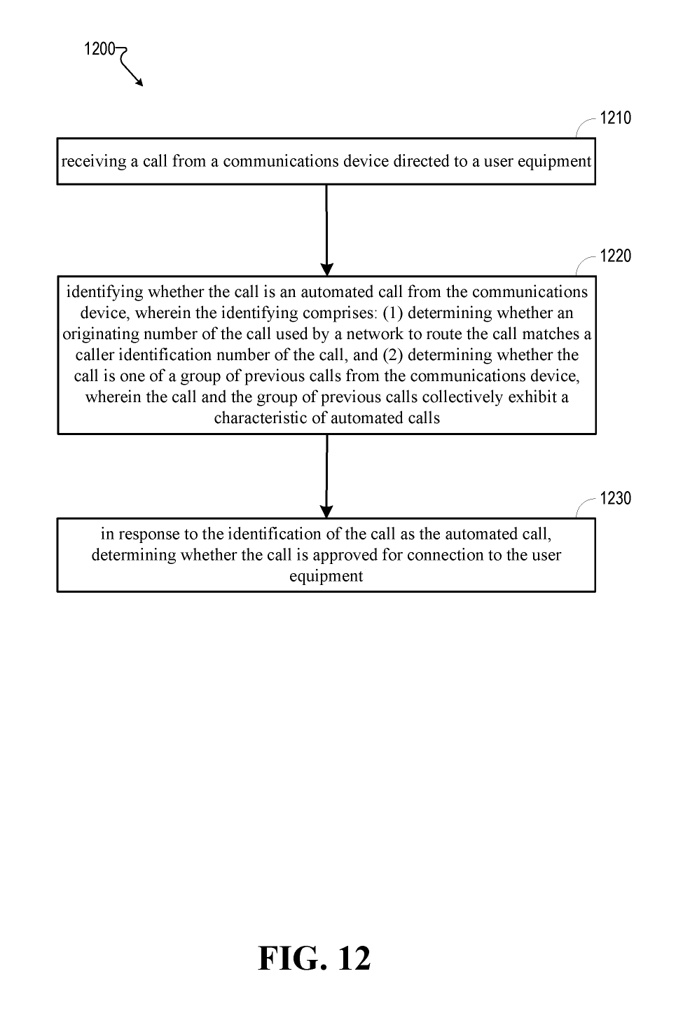

Referring now to FIG. 12, in example embodiments, there is provided a machine-readable storage medium comprising executable instructions that, when executed by a processor, facilitate performance of operations 1200.

The operations can comprise, at step 1210, receiving a call from a communications device directed to a user equipment (e.g., called party UE 220). The communications device might be an automated dialer (automated dialer 210).

Still on FIG. 12, at step 1220, the operations 1200 can further comprise identifying whether the call is an automated call from the communications device, wherein the identifying comprises determining whether an originating number of the call used by a network to route the call matches a caller identification number of the call, and determining whether the call is one of a group of received calls from the communications device, wherein the call and the group of received calls collectively exhibit a characteristic of automated calls (e.g., whether the call destination number is a call that is in a sequence, a range, or a block, or whether the calls were dialed in rapid succession with a short time-frame between each call).

At step 1230, the operations 1200 can further comprise, in response to the identification of the call as an automated call, determining whether the call is approved for connection to the user equipment.

Referring now to FIG. 13, there is illustrated a block diagram of a computer 1300 operable to execute the functions and operations performed in the described example embodiments. For example, a user device (e.g., called party UE 220), or a communications network system (e.g., automated call detection and processing system 500), can contain components as described in FIG. 13. The computer 1300 can provide networking and communication capabilities between a wired or wireless communication network and a server and/or communication device. In order to provide additional context for various aspects thereof, FIG. 13 and the following discussion are intended to provide a brief, general description of a suitable computing environment in which the various aspects of the various embodiments can be implemented to facilitate the establishment of a transaction between an entity and a third party. While the description above is in the general context of computer-executable instructions that can run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments can also be practiced in distributed computing environments where certain tasks are performed by remote processing devices that are linked through a communications network. In a distributed computing environment, program modules can be located in both local and remote memory data stores.

Computing devices typically include a variety of media, which can include computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic data stores, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media can embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference to FIG. 13, implementing various aspects described herein with regards to the network devices (e.g., server 120, switch, etc.), UEs (e.g., UE 140, called party UE 220), and user premises devices (e.g., user premise device 230) can comprise a computer 1300, the computer 1300 comprising a processing unit 1304, a system memory 1306 and a system bus 1308. The system bus 1308 couples system components comprising the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 comprises read-only memory (ROM) 1327 and random access memory (RAM) 1312. A basic input/output system (BIOS) is stored in a non-volatile memory 1327 such as ROM, EPROM, EEPROM, which BIOS contains the basic routines that help to transfer information between elements within the computer 1300, such as during start-up. The RAM 1312 can also include a high-speed RAM such as static RAM for caching data.

The computer 1300 further comprises an internal hard disk drive (HDD) 1314 (e.g., EIDE, SATA), which internal hard disk drive 1314 can also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations comprises at least one or both of Universal Serial Bus (USB) and IEEE 1294 interface technologies. Other external drive connection technologies are within contemplation of the subject embodiments.

The drives and their associated computer-readable media provide nonvolatile storage of data, data structures, computer-executable instructions, and so forth. For the computer 1300 the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer 1300, such as zip drives, magnetic cassettes, flash memory cards, cartridges, and the like, can also be used in the example operating environment, and further, that any such media can contain computer-executable instructions for performing the methods of the disclosed embodiments.

A number of program modules can be stored in the drives and RAM 1312, comprising an operating system 1330, one or more application programs 1332, other program modules 1334 and program data 1336. All or portions of the operating system, applications, modules, and/or data can also be cached in the RAM 1312. It is to be appreciated that the various embodiments can be implemented with various commercially available operating systems or combinations of operating systems.

A user can enter commands and information into the computer 1300 through one or more wired/wireless input devices, e.g., a keyboard 1338 and a pointing device, such as a mouse 1339. Other input devices 1340 can include a microphone, camera, an IR remote control, a joystick, a game pad, a stylus pen, touch screen, biometric reader (e.g., fingerprint reader, retinal scanner, iris scanner, hand geometry reader, etc.), or the like. These and other input devices are often connected to the processing unit 1304 through an input device interface 1342 that is coupled to the system bus 1308, but can be connected by other interfaces, such as a parallel port, an IEEE 2394 serial port, a game port, a USB port, an IR interface, etc.

A monitor 1344 or other type of display device can also be connected to the system bus 1308 through an interface, such as a video adapter 1346. In addition to the monitor 1344, a computer 1300 typically comprises other peripheral output devices (not shown), such as speakers, printers, etc.

The computer 1300 can operate in a networked environment using logical connections by wired and/or wireless communications to one or more remote computers, such as a remote computer(s) 1348. The remote computer(s) 1348 can be a workstation, a server computer, a router, a personal computer, portable computer, microprocessor-based entertainment device, a peer device or other common network node, and typically comprises many or all of the elements described relative to the computer, although, for purposes of brevity, only a memory/data store 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which can connect to a global communications network, e.g., the internet.

When used in a LAN networking environment, the computer 1300 is connected to the local network 1352 through a wired and/or wireless communication network interface or adapter 1356. The adapter 1356 can facilitate wired or wireless communication to the LAN 1352, which can also include a wireless access point disposed thereon for communicating with the wireless adapter 1356.

When used in a WAN networking environment, the computer 1300 can include a modem 1358, or is connected to a communications server on the WAN 1354, or has other means for establishing communications over the WAN 1354, such as by way of the internet. The modem 1358, which can be internal or external and a wired or wireless device, is connected to the system bus 1308 through the input device interface 1342. In a networked environment, program modules depicted relative to the computer, or portions thereof, can be stored in the remote memory/data store 1350. It will be appreciated that the network connections shown are exemplary and other means of establishing a communications link between the computers can be used.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This comprises at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the internet, and to wired networks (which use IEEE 802.3 or Ethernet). Wi-Fi networks operate in the unlicensed 2.4 and 5 GHz radio bands and in accordance with, for example, IEEE 802.11 standards, or with products that contain both bands (dual band), so the networks can provide real-world performance similar to the basic “10BaseT” wired Ethernet networks used in many offices.

Referring now to FIG. 14, illustrated is a schematic block diagram of a mobile device 1400 (which can be, for example, called party UE 220) capable of connecting to a network in accordance with some embodiments described herein. Although a mobile device 1400 is illustrated herein, it will be understood that other devices can be a mobile device, and that the mobile device 1400 is merely illustrated to provide context for the embodiments of the various embodiments described herein. The following discussion is intended to provide a brief, general description of an example of a suitable environment 1400 in which the various embodiments can be implemented. While the description comprises a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, comprising single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and comprises both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic data stores, or any other medium which can be used to store the desired information and which can be accessed by the computer.

Communication media typically embodies computer-readable instructions, data structures, program modules or other data in a modulated data signal such as a carrier wave or other transport mechanism, and comprises any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared and other wireless media. Combinations of the any of the above should also be included within the scope of computer-readable media.

The mobile device 1400 comprises a processor 1402 for controlling and processing all onboard operations and functions. A memory 1404 interfaces to the processor 1402 for storage of data and one or more applications 1406 (e.g., a video player software, user feedback component software, etc.). Other applications can include voice recognition of predetermined voice commands that facilitate initiation of the user feedback signals. The applications 1406 can be stored in the memory 1404 and/or in a firmware 1408, and executed by the processor 1402 from either or both the memory 1404 or/and the firmware 1408. The firmware 1408 can also store startup code for execution in initializing the mobile device 1400. A communications component 1410 interfaces to the processor 1402 to facilitate wired/wireless communication with external systems, e.g., cellular networks, VoIP networks, and so on. Here, the communications component 1410 can also include a suitable cellular transceiver 1411 (e.g., a GSM transceiver) and/or an unlicensed transceiver 1413 (e.g., Wi-Fi, WiMax) for corresponding signal communications. The mobile device 1400 can be a device such as a cellular telephone, a PDA with mobile communications capabilities, and messaging-centric devices. The communications component 1410 also facilitates communications reception from terrestrial radio networks (e.g., broadcast), digital satellite radio networks, and internet-based radio services networks.

The mobile device 1400 comprises a display 1412 for displaying text, images, video, telephony functions (e.g., a Caller ID function), setup functions, and for user input. For example, the display 1412 can also be referred to as a “screen” that can accommodate the presentation of multimedia content (e.g., music metadata, messages, wallpaper, graphics, etc.). The display 1412 can also display videos and can facilitate the generation, editing and sharing of video quotes. A serial I/O interface 1414 is provided in communication with the processor 1402 to facilitate wired and/or wireless serial communications (e.g., USB, and/or IEEE 1394) through a hardwire connection, and other serial input devices (e.g., a keyboard, keypad, and mouse). This supports updating and troubleshooting the mobile device 1400, for example. Audio capabilities are provided with an audio I/O component 1416, which can include a speaker for the output of audio signals related to, for example, indication that the user pressed the proper key or key combination to initiate the user feedback signal. The audio I/O component 1416 also facilitates the input of audio signals through a microphone to record data and/or telephony voice data, and for inputting voice signals for telephone conversations.

The mobile device 1400 can include a slot interface 1418 for accommodating a SIC (Subscriber Identity Component) in the form factor of a card Subscriber Identity Module (SIM) or universal SIM 1420, and interfacing the SIM card 1420 with the processor 1402. However, it is to be appreciated that the SIM card 1420 can be manufactured into the mobile device 1400, and updated by downloading data and software.

The mobile device 1400 can process IP data traffic through the communication component 1410 to accommodate IP traffic from an IP network such as, for example, the internet, a corporate intranet, a home network, a person area network, etc., through an ISP or broadband cable provider. Thus, VoIP traffic can be utilized by the mobile device 1400 and IP-based multimedia content can be received in either an encoded or decoded format.

A video processing component 1422 (e.g., a camera) can be provided for decoding encoded multimedia content. The video processing component 1422 can aid in facilitating the generation, editing and sharing of video quotes. The mobile device 1400 also comprises a power source 1424 in the form of batteries and/or an AC power subsystem, which power source 1424 can interface to an external power system or charging equipment (not shown) by a power I/O component 1426.

The mobile device 1400 can also include a video component 1430 for processing video content received and, for recording and transmitting video content. For example, the video component 1430 can facilitate the generation, editing and sharing of video quotes. A location tracking component 1432 facilitates geographically locating the mobile device 1400. As described hereinabove, this can occur when the user initiates the feedback signal automatically or manually. A user input component 1434 facilitates the user initiating the quality feedback signal. The user input component 1434 can also facilitate the generation, editing and sharing of video quotes. The user input component 1434 can include such conventional input device technologies such as a keypad, keyboard, mouse, stylus pen, and/or touch screen, for example.

Referring again to the applications 1406, a hysteresis component 1436 facilitates the analysis and processing of hysteresis data, which is utilized to determine when to associate with the access point. A software trigger component 1438 can be provided that facilitates triggering of the hysteresis component 1438 when the Wi-Fi transceiver 1413 detects the beacon of the access point. A SIP client 1440 enables the mobile device 1400 to support SIP protocols and register the subscriber with the SIP registrar server. The applications 1406 can also include a client 1442 that provides at least the capability of discovery, play and store of multimedia content, for example, music.

The mobile device 1400, as indicated above related to the communications component 1410, comprises an indoor network radio transceiver 1413 (e.g., Wi-Fi transceiver). This function supports the indoor radio link, such as IEEE 802.11, for the dual-mode GSM mobile device 1400. The mobile device 1400 can accommodate at least satellite radio services through a handset that can combine wireless voice and digital radio chipsets into a single handheld device.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. These components also can execute from various computer readable storage media comprising various data structures stored thereon. The components can communicate via local and/or remote processes such as in accordance with a signal comprising one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic data store, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a data store and/or any of the above computer-readable media.

As it employed in the subject specification, the term “processor” can refer to substantially any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of UE. A processor also can be implemented as a combination of computing processing units.

In the subject specification, terms such as “store,” “data store,” “data storage,” “database,” “repository,” “queue”, “storage device,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (comprising a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments comprises a system as well as a computer-readable medium comprising computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic data stores, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media.

Further, terms like “user equipment,” “user device,” “mobile device,” “mobile,” station,” “access terminal,” “terminal,” “handset,” and similar terminology, can generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “called party,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary,” where used, is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature can be combined with one or more other features of the other implementations as may be desired and advantageous for any given or particular application. Furthermore, to the extent that the terms “have”, “having”, “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art can recognize that other embodiments comprising modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A method, comprising:
receiving, by a network device comprising a processor, a call from a communications device directed to a call destination;
identifying, by the network device, whether the call is an automated call from the communications device, wherein the identifying comprises:
determining, by the network device, whether a first phone number of the call used by a network to route the call matches a second phone number identifying the call, and
analyzing, by the network device, a call behavior determined to be related to the call to determine whether the call exhibits a characteristic of automated calls; and
in response to the identification of the call as the automated call, determining, by the network device, whether the call is approved for connection to the call destination.

2. The method of claim 1, wherein the second phone number comprises a caller identification number of the call.

3. The method of claim 1, wherein the analyzing comprises determining whether the call is one of a group of previous calls from the communications device, wherein the call and the group of previous calls collectively exhibit the characteristic of automated calls.

4. The method of claim 1, wherein the determining whether the call is approved comprises accessing an entity identity data store comprising a data entry for an entity identity indicated to be allowed to initiate the automated call and determining whether the call is associated with the data entry.

5. The method of claim 1, wherein the determining whether the call is approved comprises accessing an entity identity data store comprising a data entry for an entity identity that is indicated not to be permitted to initiate the automated call and determining whether the call is associated with the data entry.

6. The method of claim 5, wherein the communications device is a first communications device, and wherein the data entry was stored at the request of a second communications device associated with the call destination.

7. The method of claim 1, further comprising, in response to determining that the call is approved for connection to the call destination, connecting, by the network device, the call to the call destination.

8. The method of claim 1, further comprising, in response to determining that the call is not approved for connection to the call destination, blocking, by the network device, the call to the call destination.

9. A device, comprising:
a processor; and
a memory that stores executable instructions that, when executed by the processor, facilitate performance of operations, comprising:
receiving a call from a communications device directed to a call destination;
identifying whether the call is an automated call from the communications device, wherein the identifying comprises:
determining whether an originating number of the call matches a caller identification number of the call, wherein the originating number is used by a network to route the call, and
analyzing a call behavior determined to be related to the call to determine whether the call exhibits a characteristic of automated calls; and
in response to the identification of the call as the automated call, determining whether the call is approved for connection to the call destination.

10. The device of claim 9, wherein the performance of operations further comprises connecting the call to the call destination in response to the call not being identified as an automated call.

11. The device of claim 9, wherein the determining whether the call is approved comprises accessing an entity identity data store comprising a data entry for an entity identity indicated to be allowed to initiate the automated call and determining whether the call is associated with the data entry.

12. The device of claim 9, wherein the determining whether the call is approved comprises accessing an entity identity data store comprising a data entry for an entity identity that is indicated not to be permitted to initiate the automated call and determining whether the call is associated with the data entry.

13. The device of claim 12, wherein the communications device is a first communications device, and wherein the data entry was stored at the request of a second communications device associated with the call destination.

14. The device of claim 9, wherein the operations further comprise, in response to determining that the call is approved for connection to the call destination, connecting the call to the call destination.

15. The device of claim 9, wherein the operations further comprise, in response to determining that the call is not approved for connection to the call destination, blocking the call to the call destination.

16. A machine-readable storage medium comprising executable instructions that, when executed by a processor, facilitate performance of operations, comprising:
receiving a call from a communications device directed to a user equipment;
identifying whether the call is an automated call from the communications device, wherein the identifying comprises:
determining whether an originating number of the call used by a network to route the call matches a caller identification number of the call, and
determining whether the call is one of a group of previous calls from the communications device, wherein the call and the group of previous calls collectively exhibit a characteristic of automated calls; and
in response to the identification of the call as the automated call, determining whether the call is approved for connection to the user equipment.

17. The machine-readable storage medium of claim 16, wherein the determining whether the call is approved comprises accessing an entity identity data store comprising a data entry for an entity identity indicated to be allowed to initiate the automated call and determining whether the call is associated with the data entry.

18. The machine-readable storage medium of claim 17, wherein the entity identity comprises an identity of a government agency.

19. The machine-readable storage medium of 16, wherein the operations further comprise, in response to determining that the call is approved for connection to the call destination, connecting the call to the user equipment.

20. The machine-readable storage medium of 16, wherein the operations further comprise, in response to determining that the call is not approved for connection to the call destination, blocking the call to the user equipment.
